(19) United States
(12) Patent Application Publication
(10) Pub. No.: US 2026/0170167 A1
(43) Pub. Date: Jun. 18, 2026

(54) PROTECTION OF SENSITIVE DATA DURING DEBUGGING OF MICROSERVICE EXECUTABLE

(71) Applicant: INTERNATIONAL BUSINESS MACHINES CORPORATION, Armonk, NY (US)

(72) Inventors: Heng Wang, Beijing (CN); Hernan A. Cunico, Holly Springs, NC (US); Xiao Ling Chen, Beijing (CN); Ming Ran Liu, Beijing (CN)

(21) Appl. No.: 18/985,149

(22) Filed: Dec. 18, 2024

(51) Int. Cl. G06F 21/62

(52) U.S. Cl. CPC G06F 21/6245; G06F 2221/033

(57) ABSTRACT

Protection of sensitive data during debugging of a microservice executable is provided by generating, by a compiler, a customized debugging information file to facilitate debugging of the microservice executable in a confidential computing environment. The customized debugging information file is customized to protect sensitive microservice data during debugging of the microservice executable. The generating includes analyzing, by the compiler, microservice source code to identify one or more code regions of sensitive microservice data to be protected during debugging of the microservice executable, and based on the analyzing, generating the customized debugging information file, where the customized debugging information file excludes debugging information data for the identified sensitive microservice data to be protected. The method also includes providing the customized debugging information file to the confidential computing environment to facilitate the debugging of the microservice executable.

### BACKGROUND

One or more aspects relate, in general, to facilitating confidential data processing, and more particularly, to protecting sensitive data during debugging of a microservice executable in a confidential computing environment.

Confidential computing refers to a security and privacy-enhanced computational approach focused on protecting data in use. Confidential computing can be used in conjunction with storage and network encryption, which protect data at rest and data in transit, respectively. Confidential computing uses, for instance, as a core technology a trusted execution environment (TEE). A variety of trusted execution environment implementations are commercially available today. In one or more implementations, a trusted execution environment allows an application to run within a set of memory pages that are encrypted by a host processor. Trusted execution environments offer a capability for running user space applications that are not visible to the operating system, virtual machine manger (VMM, or hypervisor) or middleware. A trusted execution environment provides the potential to enable security and privacy features for sensitive workloads in environments where these features were previously unavailable, such as in cloud-based computing.

### SUMMARY

Certain shortcomings of the prior art are overcome, and additional advantages are provided through the provision of a method, which includes generating, by a compiler, a customized debugging information file to facilitate debugging of a microservice executable in a confidential computing environment. The customized debugging information file is customized to protect sensitive microservice data during debugging of the microservice executable. The generating includes analyzing, by the compiler, microservice source code to identify one or more code regions of sensitive microservice data to be protected during the debugging of the microservice executable, and generating the customized debugging information file. The generated customized debugging information file excludes debugging information data for the identified sensitive microservice data to be protected during the debugging of the microservice executable. Further, the method includes providing the customized debugging information file to the confidential computing environment to facilitate the debugging of the microservice executable.

Computer program products and computer systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the disclosed inventive aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to include and/or use one or more aspects of the present disclosure;

FIG. 2 depicts one embodiment of a computer program product with a sensitive data debug protect code, in accordance with one or more aspects of the present disclosure;

FIG. 3 depicts one embodiment of a sensitive data debug protect process, in accordance with one or more aspects of the present disclosure;

FIG. 4 depicts one example of generating a standard debugging information file by a compiler during compiling of an exemplary source code segment, which is to be customized in accordance with one or more aspects of present disclosure;

FIG. 5 is a further example of a computing environment including and/or using one or more aspects of the present disclosure;

FIG. 6A is an exemplary data structure identifying new sensitive information start and end flags (or keywords) for selective use in a microservice source code to be compiled, in accordance with one or more aspects of the present disclosure;

FIG. 6B depicts one example of generating a customized debugging information file for an exemplary source code segment, in accordance with one or more aspects of the present disclosure; and

FIG. 7 depicts a further embodiment of a sensitive data debug protect workflow, in accordance with one or more aspects of the present disclosure.

### DETAILED DESCRIPTION

Aspects of the present disclosure and certain features, advantages, and details thereof, are explained more fully below with reference to the non-limiting example(s) illustrated in the accompanying drawings. Descriptions of well-known software, systems, devices, tools, processing techniques, etc., are omitted so as not to unnecessarily obscure the disclosure in detail. It should be understood, however, that the detailed description and the specific example(s), while indicating aspects of the disclosure, are given by way of illustration only, and are not by way of limitation. Various substitutions, modifications, additions, and/or arrangements, within the spirit and/or scope of the underlying inventive concepts will be apparent to those skilled in the art for this disclosure. Note further that reference is made below to the drawings, where the same or similar reference numbers used throughout different figures designate the same or similar components. Also, note that numerous inventive aspects and features are disclosed herein, and unless otherwise inconsistent, each disclosed aspect or feature is combinable with any other disclosed aspect or feature as desired for a particular application of the concepts disclosed.

Note also that illustrative embodiments are described below using specific code, designs, architectures, protocols, layouts, schematics, systems, or tools only as examples, and not by way of limitation. Furthermore, the illustrative embodiments are described in certain instances using particular software, hardware, tools, and/or data processing environments only as example for clarity of description. The illustrative embodiments can be used in conjunction with other comparable or similarly purposed structures, systems, applications, architectures, etc. One or more aspects of an illustrative embodiment can be implemented in software, hardware, or a combination thereof.

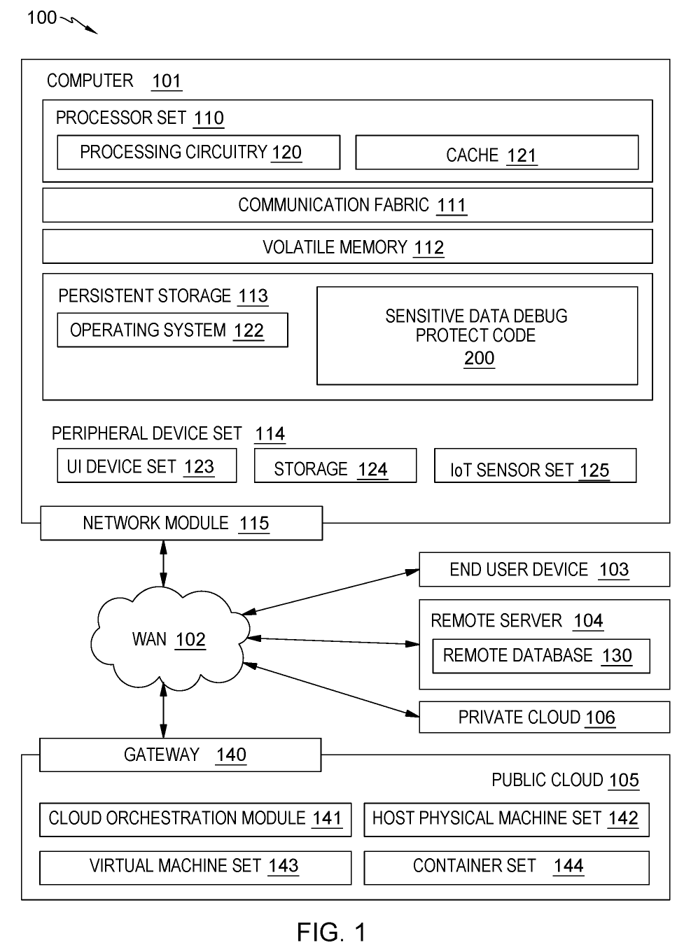

As understood by one skilled in the art, program code, as referred to in this application, can include software and/or hardware. For example, program code in certain embodiments of the present disclosure can utilize a software-based implementation of the functions described, while other embodiments can include fixed function hardware. Certain embodiments combine both types of program code. Examples of program code, also referred to as one or more programs, are depicted in FIG. 1, including operating system 122 and sensitive data debug protect code 200, which are stored in persistent storage 113.

In one or more aspects, methods, computer program products and computer systems are provided herein that facilitate confidential data processing, and in particular, that protect sensitive data during debugging of a microservice executable in a confidential computing environment. In one or more embodiments, a sensitive data debug protect code and process are disclosed to protect sensitive microservice data during the debugging of microservice executables. Advantageously, the code and processes disclosed facilitate effective diagnosing and debugging of a microservice executable, while implementing adjustable controls to selectively protect sensitive data in a confidential computing environment. In one or more embodiments, the process involves tagging, or flagging, sensitive microservice data in selected code segments that should not be accessible to the debugger. In one or more embodiments, the tagging uses specific flags or keywords inserted into the microservice source code about one or more code regions of sensitive microservice data to be protected during the debugging of the microservice executable. The flags (or keywords) are then used to generate a customized debugging information file during compiling of the microservice source code. The customized debugging information file is, in one embodiment, provided to (e.g., upload to, forward to, or read by) the confidential computing environment and used during debugging by the debugger server, which loads the customized debugging information file and consumes the file during debugging, thereby ensuring that the specific identified code regions of sensitive microservice data remain inaccessible to the debugger.

For instance, in one or more aspects, sensitive data debug protect code and processes are provided that facilitate selective debugging of microservices within, for instance, a cloud-based computing environment, such as a Debug-as-a-Service (DaaS) in a cloud environment which enables debugging of workflow processes running on a virtual machine. In one or more aspects, the sensitive data debug protect processes disclosed herein include adding new flags or keywords (e.g., SI_START and SI_END) to the microservice source code to restrict debug access to different regions of the microservice executable, or binary code. Based on insertion of the new flags or keywords, the compiler excludes generating debug information data for the protected areas of the microservice source code when generating a customized debugging information file. In one or more aspects, a customized debug (-cd) option is introduced in the compiler, which enables or disables the creation of a customized debugging information file. When enabled, the option indicates the compiler is running in customized debugging mode. In one or more aspects, a customized debugging information streamlining module is introduced into the compiler to facilitate tailoring the debugging information. In embodiments, the customized debugging information file can be uploaded to the confidential computing environment. When debugging the corresponding microservice executable, the debugger consumes the customized debugging information to selectively display or disclose only the unprotected, nonsensitive debugging information areas, thereby ensuring that the sensitive microservice data areas remain hidden in the debugging process.

One or more aspects of the present disclosure are incorporated in, performed and/or used by a computing environment. As examples, the computing environment can be of various architectures and of various types, including, but not limited to: digital signal processing, edge-based computing, personal computing, client-server, distributed, virtual, emulated, partitioned, non-partitioned, cloud-based, quantum, grid, time-sharing, clustered, peer-to-peer, mobile, having one node or multiple nodes, having one or more processor sets, each with one processor or multiple processors, and/or any other type of environment and/or configuration, etc., that is capable of executing a process (or multiple processes) that, e.g., perform processing, such as disclosed herein. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As illustrated in FIG. 1, computing environment 100 contains an example of an environment for the execution of at least some of the computer code involved in performing the inventive methods, such as sensitive data debug protect code or block 200. In addition to code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computing-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computing-implemented method, such that the instructions thus executed will instantiate the methods specified in flowcharts and/or narrative descriptions of computing-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in code 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a- service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. Further, in one or more embodiments, one or more of the components/modules of FIG. 1 need not be included in the computing environment and/or are not used for one or more aspects of the present disclosure. Further, in one or more embodiments, additional and/or other components/modules can be used. Other variations are possible.

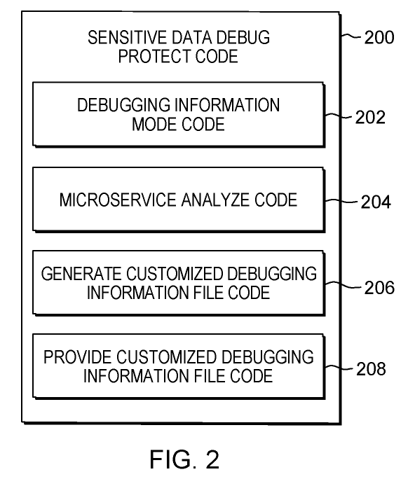

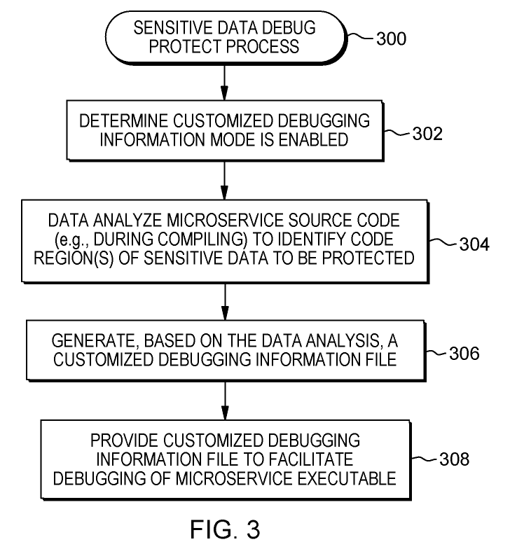

By way of example, one or more embodiments of a sensitive data debug protect code and workflow are described initially with reference to FIGS. 2-3. FIG. 2 depicts one embodiment of sensitive data debug protect code 200 that includes code or instructions to perform sensitive data debug protect processing, in accordance with one or more aspects of the present disclosure, and FIG. 3 depicts one embodiment of a sensitive data debug protect process workflow, in accordance with one or more aspects of the present disclosure.

Referring to FIGS. 1-2, sensitive data debug protect code 200 includes, in one example, various code or sub-modules used to perform processing, in accordance with one or more aspects of the present disclosure. The sub-modules are, e.g., computer-readable program code (e.g., instructions) in computer-readable media (e.g., persistent storage (e.g., persistent storage 113, such as a disk) and/or a cache (e.g., cache 121), as examples). The computer-readable media can be part of a computer program product and can be executed by and/or using one or more processors and/or computers, such as computer(s)101; one or more processor sets 110; processors, such as one or more processors of processor set 110; and/or processing circuitry, such as processing circuity of processor set 110, etc.

As noted, FIG. 2 depicts one embodiment of sensitive data debug protect code 200 which, in one or more implementations, includes, or facilitates, sensitive data debug protect processing, in accordance with one or more aspects of the present disclosure. In the embodiment of FIG. 2, example code, or sub-code, of sensitive data debug protect code 200 includes debugging information mode code 202 to, for instance, determine by the compiler whether customized debugging information mode is enabled. In one or more embodiments, the sensitive data debug protect code 200 further includes microservice analyze code 204 to data analyze, by the compiler (based on determining that the customized debugging information mode is enabled), the microservice source code to identify one or more code regions of sensitive microservice data to be protected during the debugging of the microservice executable. In embodiments, sensitive data debug protect code 200 further includes generate customized debugging information file code 206 to generate, based on the data analyzing, a customized debugging information file which, for instance, excludes (at least in part) debugging information data or entries for the identified sensitive microservice data to be protected during the debugging of the microservice executable. In embodiments, sensitive data debug protect code 200 further includes provide customized debugging information file code 208 to, for instance, provide the customized debugging information file to the computing environment to run (or running) the microservice executable, and facilitate the confidential debugging of the microservice executable by the debug server of the execution environment (e.g., confidential computing environment).

Note also that although various code or sub-modules are described herein, a sensitive data debug protect code, such as disclosed, can use, or include, additional, fewer, and/or different code/sub-modules. A particular code can include additional code, including code of other sub-modules, or less code. Further, additional and/or fewer code/sub-modules can be used. Many variations are possible.

In one or more embodiments, the sensitive data debug protect code is used, in accordance with one or more aspects of the present disclosure, to perform sensitive data debug protect processing. FIG. 3 depicts one example of a sensitive data debug protect process 300, such as disclosed herein. The process is executed, in one or more embodiments, by a computer (e.g., computer 101 (FIG. 1), a computing device (such as a cloud-based computing device, server, compiler, etc.) and/or one or more processor sets, such as a processor or processing circuitry (e.g., of processor set 110 of FIG. 1). In one example, code or instructions implementing the process, are part of a code or module, such as sensitive data debug protect code 200 of FIGS. 1-2. In other examples, the code can be included in one or more other modules and/or one or more other sub-modules of one or more other modules. Various options are available.

As illustrated in FIG. 3, in one example, sensitive data debug protect process 300 executing on one or more computers (e.g., computer 101 of FIG. 1), one or more computing devices, one or more processor sets (e.g., processor set 110 of FIG. 1, such as a processor or processing circuitry of the processor set) performs sensitive data debug protect processing such as described herein, which includes, in one or more embodiments, determining that customized debugging information mode is enabled 302. Note that, in one or more embodiments, the compiler implementing the sensitive data debug process is configured with a standard debugging information mode, during which a standard debugging information file is enabled commensurate with compiling of microservice code, and a customized debugging information mode, which when enabled directs the compiler to generate a customized debugging information file, such as described herein. In embodiments, the customized debugging information file is customized to protect select microservice data (referred to herein as sensitive microservice data) during the debugging of a microservice executable. In one or more embodiments, sensitive data debug protect process 300 further includes data analyzing microservice source code to identify (when the customized debugging information mode is enabled) code regions of sensitive data to be protected. In embodiments, the data analyzing occurs during compiling of the microservice source code into the microservice executable or binary data.

In one or more embodiments, sensitive data debug protect process 300 further includes generating, based on the data analysis, the customized debugging information file 306. In embodiments, the customized debugging information file excludes debugging information data for the identified sensitive microservice data to be protected during the debugging of the microservice executable. In one or more embodiments, sensitive data debug process 300 further includes providing the customized debugging information file to the confidential computing environment to facilitate confidential debugging of the microservice executable 308. The providing can include, for instance, transmitting or uploading, by the compiler, the customized debugging information file to the confidential computing environment, such as pursuant to a microservice executable debug request by a debug server of the confidential compiling environment. For instance, in one or more embodiments, the uploading by the compiler of the customized debugging information file can be on-demand of the confidential computing environment, such as a debugger server of the confidential computing environment.

In one or more embodiments disclosed herein, a process of debugging as a service is provided for protecting sensitive data during debugging of a microservice executable or binary code in a confidential computing environment. The sensitive data debug protect process includes analyzing, by the compiler, the microservice source code to locate in the microservice source code, for instance, a sensitive information start flag and a sensitive information end flag, which identify between them a code region of sensitive microservice data to be protected during the debugging of the microservice executable in the confidential computing environment. In embodiments, the process includes excluding, by the compiler, from the customized debugging information file debugging information data or entries for the identified code region between the sensitive information start flag and end flag identified in the microservice source code. In one or more embodiments, the process includes compiling, by the compiler, the microservice source code into the microservice executable, and during the compiling, determining that the customized debugging information mode is enabled, where generating the customized debugging information file is based on the customized debugging information mode being enabled. In one or more embodiments, the process further includes, during compiling of the microservice source code into the microservice executable, parsing the microservice source code, and performing sematic analysis on the parsed microservice source code to identify via the sensitive data start and end flags, one or more code regions of sensitive microservice data to be protected during the debugging of the microservice executable. In one or more embodiments, the sensitive microservice data to be protected includes data or code to be protected, such as microservice variable data and/or microservice function data, in one or more identified code regions of the microservice source code.

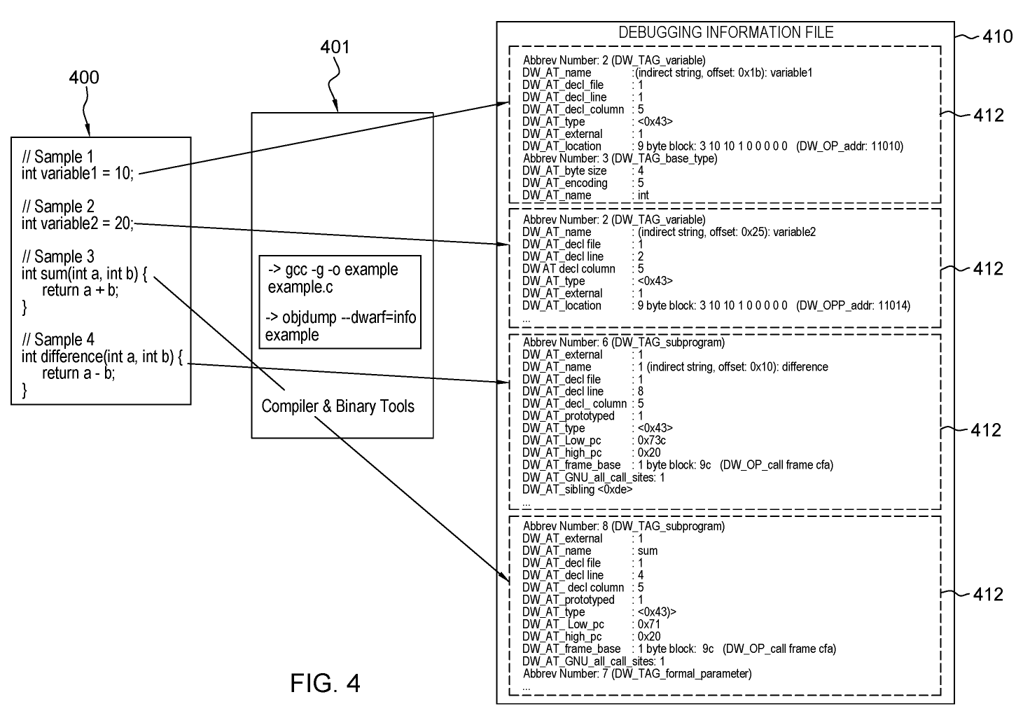

FIG. 4 depicts one example of a standard DWARF (Debugging With Attributed Record Formats) debugging information file 410 generated by a compiler 401 for compiling of an exemplary source code segment 400. In the example illustrated, standard debugging information file 410 includes debugging information entries 412 for the different microservice data depicted, which includes variable data and function data, of exemplary source code segment 400. Note that DWARF debugging information is illustrated herein in FIG. 4, by way of example only. As known, DWARF is a debugging file format that facilitates compilers and debuggers supporting source-level debugging. DWARF is a widely used, standardized debugging format which uses a data structure referred to as Debugging Information Entry to represent each variable, type, procedure, etc. The Debugging Information Entry includes a tag and attributes (key-value pairs). In embodiments, the standard debugging information file 410 is either uploaded to, for instance, a confidential computing environment for use during debugging, or provided on demand, such as when a user or debug client wishes to debug a microservice executable (i.e., the microservice binary code). In one or more embodiments, the debugging information file is generated when the compiler compiles the microservice source code into the microservice executable, or binary file. As illustrated in the example of FIG. 4, the standard debugging information file converts, in embodiments, the data of the exemplary source code segment into a computing readable file, with each aspect of the code segment being converted to a respective debugging information entry, or debugging information data, in the example depicted.

Using a standard debugging information file, such as described above in connection with FIG. 4, in a confidential computing environment, can result in disclosure of sensitive microservice data during the debugging process since most aspects of the source code are converted to respective debugging information entries in the standard debugging information file.

Disclosed herein are sensitive data debug protect code and processes which address this issue, and seamlessly integrate into, for instance, a Debug as a Service (DaaS) model, which enables secure and efficient debugging of microservices within confidential computing environments. Debugging within a confidential computing environment means that sensitive data, and intellectual property contained in the microservices, can remain protected even during a debugging process. This reduces the chance of data leakage and unauthorized data access. Many industries are bound by strict regulatory requirements regarding data privacy and security. By providing a debugging solution that adheres to the principles of confidential computing, the present disclosure facilitates maintaining compliance with regulations. Further, the sensitive data debug protect code and processes disclosed herein can be used in a variety of execution environments.

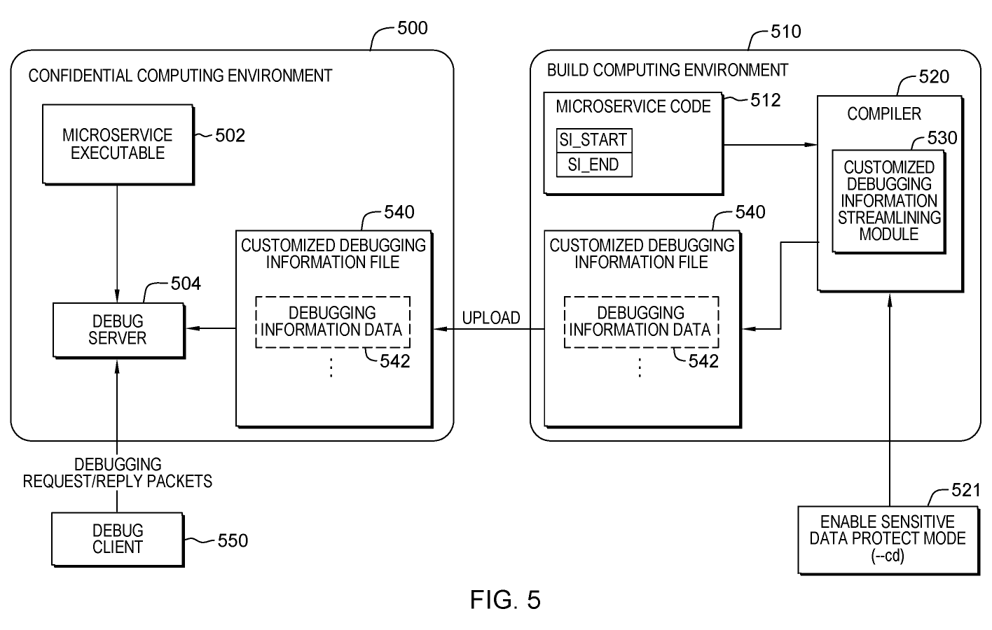

FIG. 5 depicts a further example of a computing environment including and/or using one or more aspects of the present disclosure. In one or more embodiments, the computing environment includes a confidential computing environment 500 and a build computing environment 510, which are shown as separate computing environments by way of example only. In one or more embodiments, confidential computing environment 500 and build computing environment 510 can each be implemented as part of, or include, a computing environment such as computing environment 100 described above in connection with FIG. 1. By way of example, confidential computing environment 500 includes one or more microservice executables 502 and a debug server 504 (including debug server program code), which receives one or more debugging requests from a debug client 550, and provides one or more debugging reply packets in response to debugging-related request(s). As noted, the sensitive data debug protect process and code disclosed herein facilitate selective debugging of microservice executables in a confidential computing environment, such as a cloud-based, confidential computing environment.

As illustrated in the embodiment of FIG. 5, the novel processes include, in build computing environment 510, obtaining the microservice source code 512, which (in one or more embodiments) includes one or more sensitive information start and end flag pairs to restrict during debugging access to the sensitive microservice data between each pair of sensitive information start and end flags. Based on this microservice source code, the compiler 520, and in particular, a customized debugging information streamlining module 530 added to (or accessed by) compiler 520, excludes generating debug information data for the protected sensitive microservice data when generating the customized debugging information file 540. In one or more embodiments, the microservice code can be updated, for instance, either manually or via one or more automated tools, to add one or more pairs of sensitive information start (SI_START) and sensitive information end (SI_END) flags to enclose one or more variables and/or functions to be protected. As described herein, the customized debugging information file 540 includes debugging information data or entries 542 for any unprotected microservice data areas in the microservice source code outside the one or more sensitive information start and end flag pairs.

As illustrated in FIG. 5, in one or more embodiments, compiler 520 (such as customized debugging information streamlining module 530) further determines whether customized debugging information mode is enabled, with the customized debugging information file being generated when the customized debugging information mode is enabled. In one embodiment, an enable sensitive data protect mode signal 521, such as a customize debugging (-cd) compilation option, is introduced to enable the customized debugging compilation mode. Once activated during the compilation process, the customized debugging information streamlining module 530 streamlines the debug information entry information in the customized debugging information file by excluding debug information entry information for the protected sensitive microservice data areas in the microservice executable being compiled, resulting in the debugging information file lacking debugging information for the protected sensitive microservice data.

In one or more embodiments, confidential computing environment 500 is an example of a runtime environment, which runs the debug server 504 or debugging tool server. The customized debugging information file is, in one or more embodiments, uploaded to the confidential computing environment. When debugging the corresponding microservice executable, the debug server 504 consumes the customized debugging information file, resulting in (or allowing) selective display of only unprotected debugging information, ensuring that the sensitive data or sensitive areas of the microservice code remain hidden to the debug server 504, and the debug client 500. In one or more embodiments, debug client 550 is a debugging tool client executing, for instance, on a remote computing environment from the confidential computing environment. In one or more embodiments, debug client 550 sends the debug server request packets and receives debug reply packets and can display the received information to a user of the debug client.

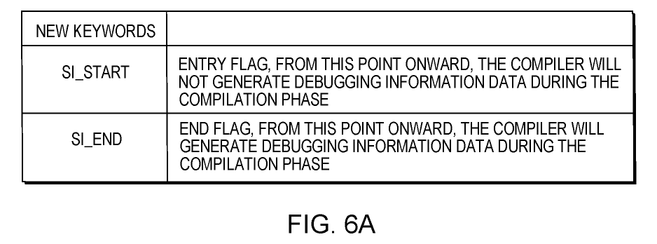

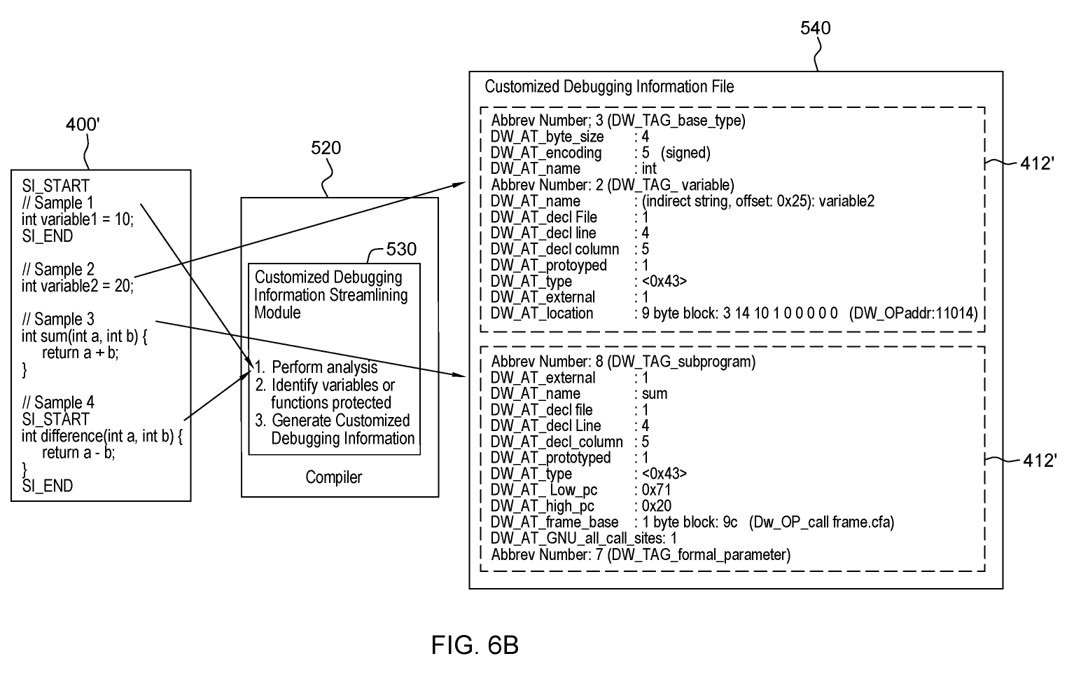

FIG. 6A is an exemplary data structure identifying a new sensitive information start (SI_START) flag and sensitive information end (SI_END) flag. In one or more embodiments, the SI_START flag indicates that from that point on in source code, the compiler (or e.g., the customized debugging information streamlining module) is not to generate debugging information data for the debugging information file during the compilation phase. For instance, in one or more embodiments, the SI_START flag signals the customized debugging information streamlining module not to generate DWARF during the compilation phase from that point on. When encountered, the SI_END flag instructs the compiler, or customized debugging information streamlining module, that from that point onward the compiler is to generate the standard debugging information data during the compilation phase. In this manner, one or more distinct source code areas can have debugging information data omitted from the customized debugging information file, and therefore be unavailable to the debug server during the debugging process.

FIG. 6B depicts one embodiment of a customized debugging information file for an exemplary source code segment 400′ processed by customized debugging information streamlining module 530 of compiler 520 during compilation processing. As noted, in one or more embodiments, customized debugging information streamlining module 530 executes, includes and/or implements, sensitive data debug protect code and processing such as described herein. In the customized debugging information enable mode, customized debugging information streamlining module 530 data analyzes the microservice code to, in part, identify, for instance, sensitive information start and end (SI_START, SI_END) flag pairs. As discussed, in one or more embodiments, software developer(s) and/or automation tool(s) have annotated the sensitive microservice code areas with specific attributes to indicate sensitivity of the data, such as the SI_START and SI_END flag pairs. Customized debugging information streamlining module 530 identifies the sensitive microservice data (e.g., variables and/or functions of the code) protected by the sensitive information start and end flags. For instance, during compilation, customized debugging information streamlining module 530 parses the source code, performs semantic analysis, and identifies variables or functions to be protected within the microservice source code. In generating the customized debugging information file, the customized debugging information streamlining module 530 ensures that debugging information entries for the sensitive microservice data are not generated or included in the customized debugging information file. An example of this is illustrated in FIG. 6B, where only the unprotected source code is used to generate debugging information data or entries 412′ for the customized debugging information file 540.

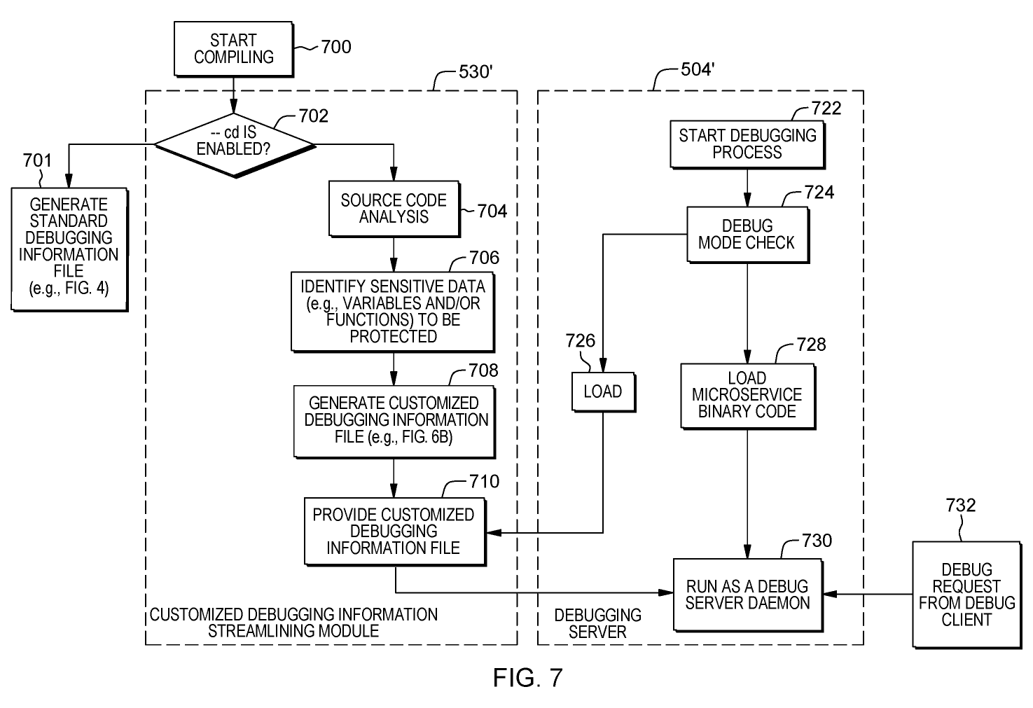

FIG. 7 depicts a further embodiment of a sensitive data debug protect workflow, in accordance with one or more aspects of the present disclosure. In the embodiment illustrated, the compiler starts compiling 700 a microservice executable from the source code, and the compiler, e.g., customized debugging information streamlining module 530 of the compiler, determines whether customized debugging information mode is enabled 702. For instance, in the embodiment of FIG. 5, the compiler, or customized debugging information streamlining module 530 determines whether -cd is enabled. If “no”, then a standard debugging information file 701 is generated. For instance, in one or more embodiments, the standard debugging information file can be a standard DWARF debugging information file generated, such as described above in connection with FIG. 4. Note that, as used herein, customized debugging information streamlining module 530′ is one embodiment only of the processing implemented by customized debugging information streamlining module 530 of FIG. 5, and debug server 504′ processing represents one embodiment only of processing implemented by debug server 504 of FIG. 5.

Assuming that customized debugging information mode is enabled, then the microservice source code is analyzed by the customized debugging information streamlining module 704 and the SI_START and SI_END flags are parsed to identify the enclosed variables and functions that are to be protected, that is, to identify the sensitive microservice data to be protected 706. The customized debugging information file 708 is generated, with the customized debugging information file excluding debugging information data for the identified sensitive microservice data to be protected during the debugging of the microservice executable. The customized debugging information file can be provided 710 at time of compilation to, for instance, debug server 504′ of the confidential computing environment, or can be provided on demand, such as upon receipt of a load request from debug server 504′. The debug server 504′ starts the debugging process 722 with a debug mode check as an option or environment variable 724. In one or more embodiments, the debugging server 504′ loads the customized debugging information file 710 to facilitate running a debug server daemon 730, which consumes the customized debugging information file, and in particular, the debug information data or entries for the functions, variables, types and line information included within the customized debugging information file. The debugging server 504′ also loads the microservice executable or binary code in address space, and obtains a real loading address of the microservice binary code. The debug server daemon 730 runs pursuant to a debug request from a debug client 732. The debug server daemon communicates with the debug client 732.

As noted herein, in one or more embodiments, within the microservice source code, the variables and functions enclosed by SI_START and SI_END have their debugging information streamlined when generating the customized debugging information file. This customized debugging information file is then uploaded to the confidential computing environment, such as the debugging server, which prevents the debugging client from accessing these variables and functions as part of the debug process, thereby achieving the desired data protection for the identified sensitive microservice data.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer-readable code into a computing system, in which the code in combination with the computing system is capable of performing one or more embodiments.

Yet a further aspect, a process for integrating computing infrastructure comprising integrating computer-readable code into a computer system may be provided. The computer system comprises a computer-readable medium, in which the computer medium comprises one or more embodiments. The code in combination with the computer system is capable of performing one or more embodiments.

Although various embodiments are described above, these are only examples. For example, other models and/or data may be used. Moreover, additional, less and/or other code may be used. Although particular code may be provided as an example of performing a particular operation or task, additional and/or other code may be used. Code may be combined and/or separated into code subsets. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting of the disclosure. As used herein, the singular forms "a", "an" and "the" are intended to include the plural forms as well, unless the context clearly indicates otherwise. It will be further understood that the terms "comprise" (and any form of comprise, such as "comprises" and "comprising"), "have" (and any form of have, such as "has" and "having"), "include" (and any form of include, such as "includes" and "including"), and "contain" (and any form contain, such as "contains" and "containing") are open-ended linking verbs. As a result, a method or device that "comprises", "has", "includes" or "contains" one or more steps or elements possesses those one or more steps or elements, but is not limited to possessing only those one or more steps or elements. Likewise, a step of a method or an element of a device that "comprises", "has", "includes" or "contains" one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A method comprising:
generating, by a compiler, a customized debugging information file to facilitate debugging of a microservice executable in a confidential computing environment, the customized debugging information file being customized to protect sensitive microservice data during the debugging of the microservice executable, the generating comprising:
analyzing, by the compiler, microservice source code to identify one or more code regions of the sensitive microservice data to be protected during the debugging of the microservice executable;
based on the analyzing, generating the customized debugging information file, wherein the customized debugging information file excludes debugging information data for the identified one or more regions of sensitive microservice data to be protected during the debugging of the microservice executable; and
providing the customized debugging information file to the confidential computing environment to facilitate the debugging of the microservice executable.

2. The method of claim 1, further comprising determining, by the compiler, that a customized debugging information mode is enabled, wherein the generating, by the compiler, the customized debugging information file is based on determining by the compiler that the customized debugging information mode is enabled.

3. The method of claim 1, wherein the analyzing, by the compiler, the microservice source code further comprises analyzing by the compiler the microservice source code to locate in the microservice source code a sensitive information start flag and a sensitive information end flag, which identify there between a code region of sensitive microservice data of the one or more code regions of sensitive microservice data to be protected during the debugging of the microservice executable in the confidential computing environment.

4. The method of claim 3, further comprising excluding, by the compiler, from the customized debugging information file debugging information data for the identified code region between the sensitive information start flag and the sensitive information end flag in the microservice source code.

5. The method of claim 3, further comprising:
compiling, by the compiler, the microservice source code into the microservice executable; and
during the compiling, determining, by the compiler, that a customized debugging information mode is enabled, wherein generating the customized debugging information file is based on the customized debugging information mode being enabled.

6. The method of claim 5, wherein the analyzing further comprises, during compiling of the microservice source code into the microservice executable, parsing the microservice source code, and performing sematic analysis on the parsed microservice source code to identify via the sensitive information start and end flags the one or more code regions of sensitive microservice data to be protected during the debugging of the microservice executable.

7. The method of claim 1, wherein generating, by the compiler, the customized debugging information file is performed by a customized debugging information streamlining module of the compiler which tailors debugging information data in a customized debugging information mode of the compiler by excluding debugging information entries for the identified sensitive microservice data to be protected.

8. The method of claim 1, further comprising receiving, by the compiler, the microservice source code to be compiled into the microservice executable, wherein the microservice source code includes one or more sensitive information start and end flag pairs identifying one or more code regions of the microservice source code with sensitive microservice data to be protected when generating, by the compiler, the customized debugging information file.

9. The method of claim 8, wherein the identified one or more code regions of sensitive microservice data to be protected during debugging of the microservice executable in the confidential computing environment include at least one of microservice variable data and microservice function data to be protected during debugging of the microservice executable.

10. A computer program product comprising:
one or more computer-readable storage media; and
program instructions stored on the one or more computer-readable storage media to perform operations comprising:
generating, by a compiler, a customized debugging information file to facilitate debugging of a microservice executable in a confidential computing environment, the customized debugging information file being customized to protect sensitive microservice data during the debugging of the microservice executable, the generating comprising:
analyzing, by the compiler, microservice source code to identify one or more code regions of the sensitive microservice data to be protected during the debugging of the microservice executable;
based on the analyzing, generating the customized debugging information file, wherein the customized debugging information file excludes debugging information data for the identified one or more regions of sensitive microservice data to be protected during the debugging of the microservice executable; and
providing the customized debugging information file to the confidential computing environment to facilitate the debugging of the microservice executable.

11. The computer program product of claim 10, further comprising determining, by the compiler, that a customized debugging information mode is enabled, wherein the generating, by the compiler, the customized debugging information file is based on determining by the compiler that the customized debugging information mode is enabled.

12. The computer program product of claim 10, wherein the analyzing, by the compiler, the microservice source code further comprises analyzing by the compiler the microservice source code to locate in the microservice source code a sensitive information start flag and a sensitive information end flag, which identify there between a code region of sensitive microservice data of the one or more code regions of sensitive microservice data to be protected during the debugging of the microservice executable in the confidential computing environment.

13. The computer program product of claim 12, further comprising excluding, by the compiler, from the customized debugging information file debugging information data for the identified code region between the sensitive information start flag and the sensitive information end flag in the microservice source code.

14. The computer program product of claim 12, further comprising:
compiling, by the compiler, the microservice source code into the microservice executable; and
during the compiling, determining, by the compiler, that a customized debugging information mode is enabled, wherein generating the customized debugging information file is based on the customized debugging information mode being enabled.

15. The computer program product of claim 14, wherein the analyzing further comprises, during compiling of the microservice source code into the microservice executable, parsing the microservice source code, and performing sematic analysis on the parsed microservice source code to identify via the sensitive information start and end flags the one or more code regions of sensitive microservice data to be protected during the debugging of the microservice executable.

16. The computer program product of claim 10, further comprising receiving, by the compiler, the microservice source code to be compiled into the microservice executable, wherein the microservice source code includes one or more sensitive information start and end flag pairs identifying one or more code regions of the microservice source code with sensitive microservice data to be protected when generating, by the compiler, the customized debugging information file.

17. A computer system comprising:
at least one processor set;
one or more computer-readable storage media; and
program instructions stored on the one or more computer-readable storage media to cause the at least one processor set to perform operations comprising:
generating, by a compiler, a customized debugging information file to facilitate debugging of a microservice executable in a confidential computing environment, the customized debugging information file being customized to protect sensitive microservice data during the debugging of the microservice executable, the generating comprising:
analyzing, by the compiler, microservice source code to identify one or more code regions of the sensitive microservice data to be protected during the debugging of the microservice executable;
based on the analyzing, generating the customized debugging information file, wherein the customized debugging information file excludes debugging information data for the identified one or more regions of sensitive microservice data to be protected during the debugging of the microservice executable; and
providing the customized debugging information file to the confidential computing environment to facilitate the debugging of the microservice executable.

18. The computer system of claim 17, wherein the analyzing, by the compiler, the microservice source code further comprises analyzing by the compiler the microservice source code to locate in the microservice source code a sensitive information start flag and a sensitive information end flag, which identify there between a code region of sensitive microservice data of the one or more code regions of sensitive microservice data to be protected during the debugging of the microservice executable in the confidential computing environment.

19. The computer system of claim 18, further comprising:
compiling, by the compiler, the microservice source code into the microservice executable; and
during the compiling, determining, by the compiler, that a customized debugging information mode is enabled, wherein generating the customized debugging information file is based on the customized debugging information mode being enabled.

20. The computer system of claim 19, wherein the analyzing further comprises, during compiling of the microservice source code into the microservice executable, parsing the microservice source code, and performing sematic analysis on the parsed microservice source code to identify via the sensitive information start and end flags the one or more code regions of sensitive microservice data to be protected during the debugging of the microservice executable.
